(19) United States
(12) Patent Application Publication
(10) Pub. No.: US 2015/0375816 A1
(43) Pub. Date: Dec. 31, 2015

(54) APPARATUS FOR ALIGNING TRACK SEGMENTS OF TRACK ASSEMBLY

(71) Applicant: Caterpillar Global Mining LLC, Oak Creek, WI (US)

(72) Inventors: SIVAKUMAR RAMAIYAN, CHENNAI (IN); BRETT E. BURKE, WASHINGTON, IL (US); GNANASEKAR JEEVANANTHAM, CHENNAI (IN)

(73) Assignee: Caterpillar Global Mining LLC, Oak Creek, WI (US)

(21) Appl. No.: 14/852,632

(22) Filed: Sep. 14, 2015

(51) Int. Cl. B62D 55/32

(52) U.S. Cl. CPC B62D 55/32

(57) ABSTRACT

An apparatus for aligning a track of a track assembly with respect to another track a link is provided. The track assembly includes a link that further includes a pad portion defining a top surface and a bottom surface. The apparatus includes a first tube, a pair of upper connecting members, a second tube, a pair of hitch members, and a pair of lower connecting members. A projecting portion of each of the pair of upper connecting members and an extending portion of each of the pair of lower connecting members are adapted to removably retain the first tube on the pad portion of the track.

### TECHNICAL FIELD

The present disclosure relates to an apparatus for aligning a track of a track assembly with respect to another track.

### BACKGROUND

Machines such as a track type tractor are used to perform operations in different industries, for example, construction, mining, transportation etc. Such machines employ track assemblies as ground engaging members to provide propulsion to the machines. The track assembly includes a series of tracks connected to each other such that a large ground contacting area is obtained. Prolonged operation of the machines results in wear of various components of the track assembly. For example, each track of the track assembly can undergo wear due to contact with other components of the track assembly and/or a ground surface. Hence, the track assembly a periodically repaired by replacing a track of the track assembly. Typically, during installing a new track pad, one track of the track assembly is pulled and aligned with respect to another track. Inaccurate alignment of the tracks can result in increased wear of various components of the track assembly and thus, in slippage of the machine during travel. Moreover, alignment of the track with respect to another track requires increased time and effort.

WO Publication Number 2013/160545 (the '545 publication) discloses a tightener for tracks. The tightener includes a left-handed hook, a right-handed hook, a rotation axis, left-handed and right-handed threads, and a ratchet handle. The ratchet handle includes a casing, a lever, and a handle. Inside the casing, a space is provided for a gearwheel and a pawl which act as torsional parts. The casing is sealed by means of a cover piece which is fastened with attaching parts. The rotation axis is fitted in holes of the casing and the cover piece such that the gearwheel is inside the casing. The pawl has a segment of teeth which matches with the mesh of the gearwheel, and the pawl is lightened from its middle part, i.e., some of the teeth of the segment are removed. The segment of the teeth is further fastened to the casing with a pin such that the pawl can swing. Both ends of the segment of the teeth can be alternately in the mesh of the gearwheel in which case the working direction of the tightener can be changed. The gearwheel is fitted in the casing so that, during tightening, the outer shell of the gearwheel leans against the inner surface of the casing. In such a case, due to the frictional force, the distribution of stress is uniformly distributed and disengages the other part of the tightener. However, the tightener of the '545 publication may not provide proper alignment of the tracks with respect to each other as the tightener uses either of the left-handed hook or the right-handed hook for a particular track. Morever, the tightener of the '545 publication has a complicated construction and operation.

### SUMMARY OF THE DISCLOSURE

In one aspect of the present disclosure, an apparatus for aligning a track of a track assembly with respect to another track is provided. The track includes a pad portion defining a top surface and a bottom surface. The apparatus further includes a first tube defining a longitudinal axis therethrough. The apparatus includes a pair of upper connecting members slidably coupled to the first tube and spaced apart from each other along the longitudinal axis. Each of the pair of upper connecting members includes a projecting portion adapted to contact the top surface of the pad portion of the track. The apparatus also includes a second tube slidably coupled to the first tube and disposed between the pair of upper connecting members. The second tube further includes a pair coupling portions extending along a direction perpendicular to the longitudinal axis. The second tube also includes an adapter portion disposed between the pair of coupling portions. The adapter portion is adapted to be selectively coupled to a winch. The second tube also includes a support portion adapted to contact the top surface of the pad portion of the track. The apparatus further includes a pair of hitch members coupled to the pair of coupling portions. Each of the pair of hitch members is adapted to be coupled to a tightening device. The apparatus further includes a pair of lower connecting members slidably coupled to the first tube. Each of the pair of lower connecting members is disposed between an adjacent upper connecting member of the pair of upper connecting members and an end of the first tube. Further, each of the pair of lower connecting members includes an extending portion adapted to abut the bottom surface of the pad portion of the track. The projecting portion of each of the pair of upper connecting members and the extending portion of each of the pair of lower connecting members are adapted to removably retain the first tube on the pad portion of the track.

Other features and aspects of this disclosure will be apparent from the following description and the accompanying drawings.

### BRIEF DESCRIPTION OF THE DRAWINGS

FIG. 1 illustrates a partial perspective view of a track assembly having an apparatus to align a track with other tracks, according to an embodiment of the present disclosure;

FIG. 2 illustrates a perspective view of the apparatus of FIG. 1, according to an embodiment of the present disclosure; and

FIG. 3 illustrates a partial perspective view of the track assembly having a pair of apparatuses, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

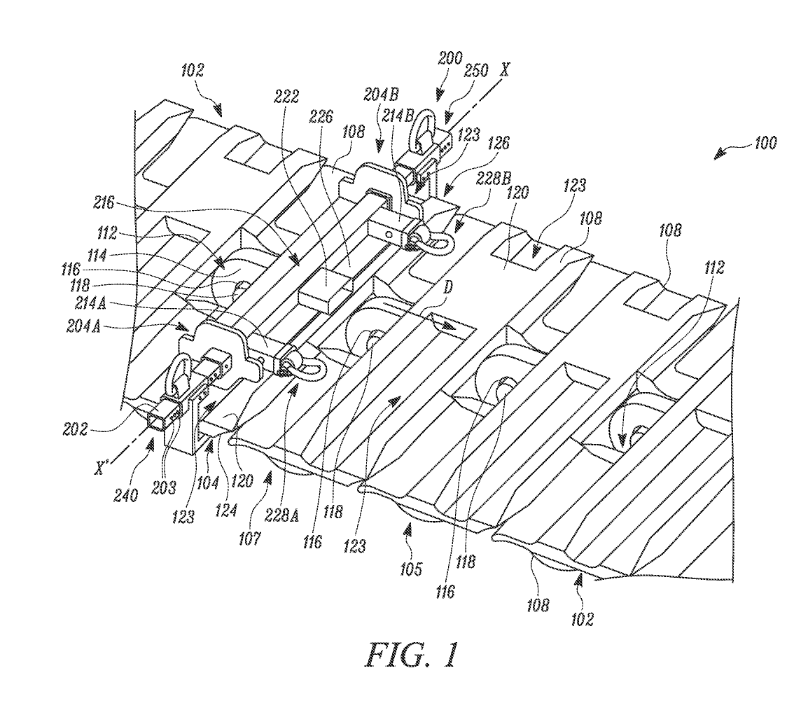

FIG. 1 illustrates a partial perspective view of a track assembly 100 having an apparatus 200, according to an embodiment of the present disclosure. The track assembly 100 can be used in excavators, track type tractors, bulldozers, or any other machines which have tracked undercarriage systems as ground engaging members for propelling the machine.

The track assembly 100 can be connected to an upper body (not shown) of a machine (not shown) such that the track assembly 100 is a ground engaging portion of the machine. Further, the track assembly 100 can be operatively connected to one or more rollers (not shown) in order to drive the track assembly 100. The track assembly 100 can be used to drive or steer the machine in a worksite (not shown). The track assembly 100 further includes multiple tracks 102. The tracks 102 are connected to each other such that a continuous structure is formed. Further, each of the tracks 102 can be selectively engaged with the rollers.

Each of the tracks 102 includes a pad portion 108 and a link portion 112 connected to the pad portion 108. The link portion 112 can be used to connect adjacent tracks 102. The link portion 112 includes multiple connecting portions 114. Each of the connecting portions 114 defines an opening 116 which receives a pin 118.

The pad portion 108 is the ground engaging member of each of the tracks 102. The pad portion 108 can also include one or more members (not shown), such as grouser bars, that provide increased traction between the tracks 102 and ground. The pad portion 108 defines a top surface 120 and a bottom surface 124. The top surface 120 contacts the ground. Further, the bottom surface 124 selectively abuts the rollers. The pad portion 108 also includes a body 126 extending between the top surface 120 and the bottom surface 124. The body 126 further defines multiple recesses 123 on the top surface 120 thereof.

Referring to FIG. 1, a portion of the track assembly 100 having a first track 104 and a second track 105 spaced apart from the first track 104 is illustrated. The track assembly 100 also includes an intermediate track 107 positioned between the first and second tracks 104, 105. The first track 104 and the second track 105 are connected to the intermediate track 107 by the pins 118.

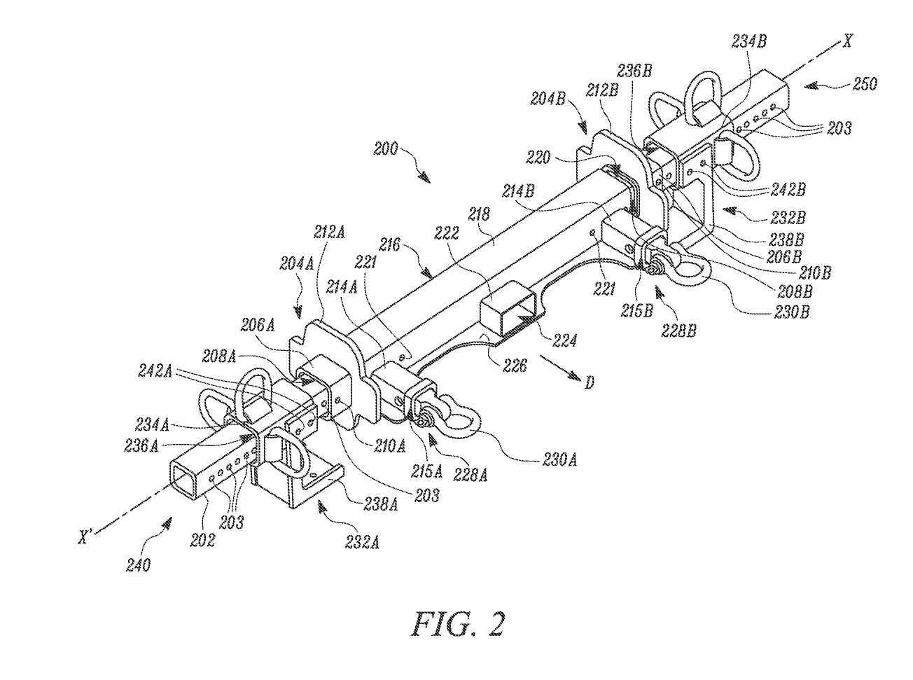

Referring to FIGS. 1 and 2, the apparatus 200 used to align the intermediate track 107 with the first and second tracks 104, 105 of the track assembly 100 is shown. The apparatus 200 is positioned on the top surface 120 of the first track 104. The apparatus 200 includes a first tube 202. The first tube 202 further includes multiple first holes 203 positioned along a length thereof. The first tube 202 also defines a longitudinal axis XX′.

The apparatus 200 further includes a pair of upper connecting members 204A, 204B. The upper connecting members 204A, 204B are attached to the first tube 202 such that the upper connecting members 204A, 204B can be moved relative to each other along the longitudinal axis XX′. Each of the upper connecting members 204A, 204B includes a base portion 206A, 206B, respectively. The base portions 206A, 206B are attached to the first tube 202. Further, each of the base portions 206A, 206B defines a first connecting opening 208A, 208B, respectively. The first connecting openings 208A, 208B receive the first tube 202 such that the upper connecting members 204A, 204B can be moved apart along the longitudinal axis XX′. Each of the base portions 206A, 206B also includes a second hole 210A, 210B, respectively. Further, a second hole of each of the second holes 210A, 210B receive a pin member (not shown) to lock a corresponding upper connecting members 204A, 204B at a location on the first tube 202.

Further, each of the upper connecting members 204A, 204B includes a projecting portion 212A, 212B, respectively. Each of the projecting portions 212A, 212B is attached to each of the base portions 206A, 206B, respectively. The projecting portions 212A, 212B contact the top surface 120 of the pad portion 108. The projecting portions 212A, 212B support the apparatus 200 on the pad portion 108 of the first track 104. Specifically, the projecting portions 212A, 212B are engaged within the recesses 123 of the first track 104 to lock the apparatus 200 thereon.

Further, shapes and dimensions of the projecting portions 212A, 212B can be defined based on shape of the tracks 104 to support and lock the apparatus 200 thereon. For example, as shown in FIG. 1, the projecting portions 212A, 212B are engaged within the recesses 123 of the first track 104 to restrict movement of the apparatus 200 along a direction ‘D’ perpendicular the longitudinal axis XX′. Moreover, orientation of the upper connecting members 204A, 204B may also be changed to engage the projecting portions 212A, 212B within the recesses 123 of the tracks 102 of track assembly 100.

The apparatus 200 also includes a second tube 216 which is positioned between the pair of upper connecting members 204A, 204B. The second tube 216 is connected to the first tube 202 such that the second tube 216 can be moved along the longitudinal axis XX′. The second tube 216 includes a tube portion 218. The tube portion 218 defines a tube opening 220. The tube opening 220 receives the first tube 202. The tube portion 218 further includes multiple tube holes 221. A tube hole of the tube holes 221 and a corresponding first hole of the first holes 203 of the first tube 202 receive a pin member (not shown) to lock the tube portion 218 at a location on the first tube 202.

The second tube 216 further includes a pair of coupling portions 214A, 214B connected to the tube portion 218. The coupling portions 214A, 214B are positioned near to each of the upper connecting members 204A, 204B, respectively. The coupling portions 214A, 214B extend in the direction ‘D’ (shown in FIG. 2) perpendicular to the longitudinal axis XX′. Further, each of the coupling portions 214A, 214B defines a first cavity 215A, 215B, respectively.

The second tube 216 further includes an adapter portion 222 connected to the tube portion 218. The adapter portion 222 is positioned between the coupling portions 214A, 214B of the second tube 216. The adapter portion 222 is adapted to connect the apparatus 200 with a winch (not shown). The adapter portion 222 further defines a second cavity 224 which receives a coupling member (not shown), for example, a hook, to connect the winch with the apparatus 200. The second tube 106 further includes a support portion 226 connected to the tube portion 218. The support portion 226 contacts the top surface 120 of the pad portion 108.

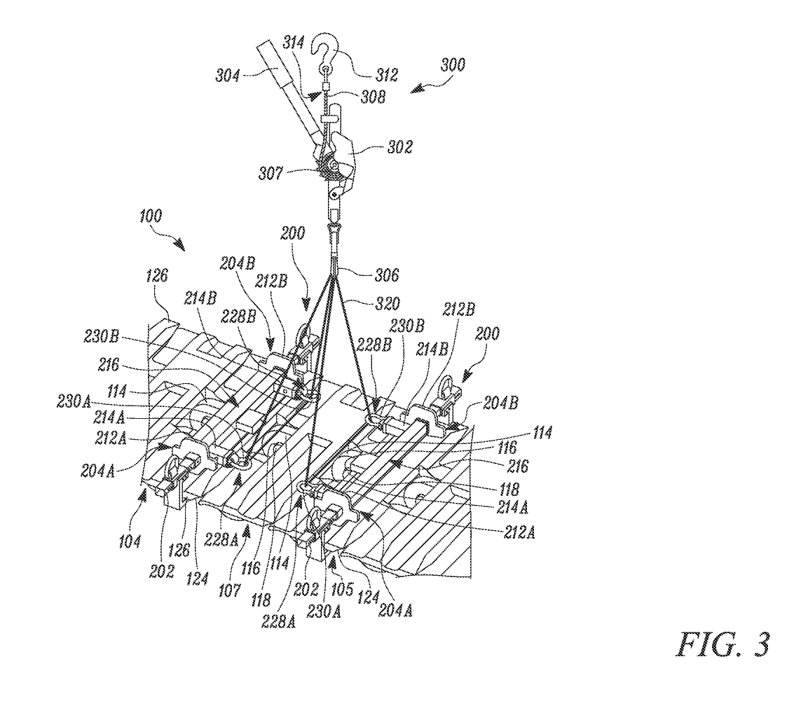

The apparatus 200 further includes a pair of the hitch members 228A, 228B. Each of the hitch members 228A, 228B is connected to each of the coupling portions, 214A, 214B, respectively. Each of the hitch members 228A, 228B includes a shank portion (not shown) and a hook portion 230A, 230B, respectively. The hook portions 230A, 230B are attached to a corresponding shank portion of the hitch members 228A, 228B, respectively. The shank portions are received within a corresponding first cavity of each of the coupling portions 214A, 214B. Further, the hook portions 230A, 230B connect the apparatus 200 with a tightening device 300 (shown in FIG. 3).

The apparatus 200 also includes a pair of lower connecting members 232A, 232B. The lower connecting member 232A is positioned between the upper connecting member 204A and a first end 240 of the first tube 202. Further, the upper connecting member 232B is positioned between the upper connecting member 204B and a second end 250 of the first tube 202.

Each of the lower connecting members 232A, 232B includes a first connecting portion 234A, 234B, respectively. The first connecting portions 234A, 234B are connected to the first tube 202. Each of the first connecting portions 234A, 234B further defines a lower connecting opening 236A, 236B, respectively. The lower connecting openings 236A, 236B receive the first tube 202 such that the lower connecting members 232A, 232B can be moved along the longitudinal axis XX′ on the first tube 202. Further, each of the lower connecting members 232A, 232B can be moved along the longitudinal axis XX′ on the first tube 202 to connect the pad portion 108 of the first track 104 with the apparatus 200. Each of the first connecting members 232A, 232B also includes two connecting holes 242A, 242B, respectively. A connecting hole of each of the connecting holes 242A, 242B and a first hole of the first holes 203 receive a pin member (not shown) to lock a corresponding connecting member at a location on the first tube 202.

Further, each of the lower connecting members 232A, 232B also includes a second connecting portion 238A, 238B, respectively. The second connecting portions 238A, 238B are connected to the first connecting portions 236A, 236B, respectively. Each of the second connecting portions 238A, 238B abuts the bottom surface 124 of the pad portion 108. In an example, the second connecting portions 238A, 238B of the lower connecting members 232A, 232B can also be connected to the body 126 of the first track 104 via fasteners, such as studs, bolts, etc.

FIG. 3 illustrates a partial perspective view of the track assembly 100 having a pair of the apparatuses 200. The hitch members 228A, 228B of each of the pair of apparatuses are attached to the tightening device 300. The tightening device 300 is a come along. The tightening device 300 includes a main body 302, and a handle 304 mounted on the main body 302. The main body 302 includes a first hook 306 used to connect with the hook portions 230A, 230B of the apparatus 200. The tightening device 300 also includes a spool 307 mounted in the main body 302 and a rope 308 wound around the spool 307. A second hook 312 is also connected to an end 314 of the rope 308. The second hook 312 can be used to connect with an external device that can be used for applying a pulling load. Alternatively, the first hook 306 can also be used to connect the tightening device 300 with the external device and the second hook 312 can be connected with the apparatus 200. As shown in FIG. 3, the tightening device 300 is used to align the intermediate track 107 with respect to the first and second tracks 104, 105 of the track assembly 100. In another embodiment, each of the pair of apparatuses 200 can be connected to the track at any location in the track assembly 100.

Although the tightening device 300 is described as a come along, however, it may be contemplated that the tightening device may be a ratchet hoist, an overhead crane etc.

### INDUSTRIAL APPLICABILITY

The present disclosure relates to the apparatus 200 for aligning adjacent tracks 102 of the track assembly 100. Referring to FIG. 3, the apparatus 200 can be connected to the tightening device 300 for facilitating alignment of adjacent tracks 102 of the track assembly 100.

Referring to FIG. 3, each of the pair of apparatuses 200 is connected to the first track 104 and the second track 105. The pair of apparatuses are used to align the intermediate track 107 disposed between the first track 104 and the second track 105 of the track assembly 100. Each of the apparatuses 200 is positioned on a corresponding top surface 140 of each of the first and second tracks 104, 105 such that coupling portions 214A, 214B of the two apparatuses 200 face each other.

The upper connecting members 204A, 204B of each of the apparatuses 200 are moved apart such that the projecting portions 212A, 212B of each of the upper connecting members 204A, 204B contact the top surfaces 120 of each of the pad portions 108. Subsequently, the lower connecting members 232A, 232B of each of the apparatuses 200 are connected to the body 126 of each of the first and second tracks 104, 105. It should be understood that shape and orientation of the upper connecting members 204A, 204B can be suitably chosen to support and lock the apparatus 200 on the track 102 of the track assembly 100.

Further, each of the hitch members 228A, 228B of each of the apparatuses receives a cable 320 such that a network loop is formed. The loop defined by the cable 320 is attached to the first hook 306 of the tightening device 300. Each of the first and second tracks 104, 105 is moved towards the intermediate track 107 by the pulling load applied by the tightening device 300 to align the openings 116 of the connecting portions 114 of the intermediate track 107 with respect to first and second tracks 104, 105. Thereby, the pins 118 can be inserted into each of the openings 116 of the connecting portions 114 to engage the intermediate track 107 to the first and second tracks 104, 105.

Alternatively, the apparatus 200 can use a winch (not shown) to align and connect a track 102 with respect to the other tracks 102 of the track assembly 100. The winch includes a cable wound therearound. In such a case, one or more hook members similar to the hitch members 228A, 228B can be connected to the adapter portions 222. The hook members can be connected to the cable of the winch. The winch applies a pulling load to move the tracks 102 towards each other to align the openings 116 of the connecting portions 114 of the tracks. Since, an alignment of the tracks could be automated; hence a reliable connection between the tracks can be obtained with minimum time and efforts.

While aspects of the present disclosure have been particularly shown and described with reference to the embodiments above, it will be understood by those skilled in the art that various additional embodiments could be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An apparatus for aligning a track of a track assembly with respect to another track, the track having a pad portion defining a top surface and a bottom surface, the apparatus comprising:
a first tube defining a longitudinal axis therethrough;
a pair of upper connecting members slidably coupled to the first tube and spaced apart from each other along the longitudinal axis, each of the pair of upper connecting members comprising a projecting portion adapted to contact the top surface of the pad portion of the track;
a second tube slidably coupled to the first tube and disposed between the pair of upper connecting members, the second tube comprising:
a pair coupling portions extending along a direction perpendicular to the longitudinal axis;
an adapter portion disposed between the pair of coupling portions, the adapter portion adapted to be selectively coupled to a winch; and
a support portion adapted to contact the top surface of the pad portion of the track;
a pair of hitch members coupled to the pair of coupling portions, wherein each of the pair of hitch members are adapted to be coupled to a tightening device; and
a pair of lower connecting members slidably coupled to the first tube, each of the pair of lower connecting members being disposed between an adjacent upper connecting member of the pair of upper connecting members and an end of the first tube, each of the pair of lower connecting members comprising a extending portion adapted to abut the bottom surface of the pad portion of the track,
wherein the projecting portion of each of the pair of upper connecting members and the extending portion of each of the pair of lower connecting members are adapted to removably retain the first tube on the pad portion of the track.
